(19) United States
(12) Patent Application Publication
(10) Pub. No.: US 2025/0126601 A1
(43) Pub. Date: Apr. 17, 2025

(54) PET LOCATING SYSTEM AND METHOD

(71) Applicant: LOCATEPET911, LLC, Scottsdale, AZ (US)

(72) Inventors: Patrick Joseph Furlong, Glendale, AZ (US); David James Duggan, JR., Glendale, AZ (US); Liza Vespi, Toronto (CA)

(73) Assignee: LOCATEPET911, LLC, Scottsdale, AZ (US)

(21) Appl. No.: 18/917,886

(22) Filed: Oct. 16, 2024

Related U.S. Application Data
(60) Provisional application No. 63/591,087, filed on Oct. 17, 2023.

(51) Int. Cl. H04W 64/00; H04M 1/72436; H04W 88/06

(52) U.S. Cl. CPC H04W 64/006; H04M 1/72436; H04W 88/06

(57) ABSTRACT

A pet locating system and method includes a pet tracking device to be worn by a pet, with the device including a Bluetooth scanner to monitor a status of a presence or an absence of Bluetooth beacons within a predefined area, a Wi-Fi module to connect to a wireless network to communicate the status with a cloud-based server, a cellular modem to communicate the status with the cloud-based server when the device is outside a range of the wireless network, and a GPS receiver to obtain location data of a pet wearing the device and communicate the location data with the cloud-based server.

### CROSS-REFERENCE TO RELATED APPLICATIONS

This application claims priority under 35 U.S.C. 119 (e) to U.S. Provisional Patent Application Ser. No. 63/591,087 filed on Oct. 17, 2023, and incorporated herein by reference.

### BACKGROUND

The present disclosure relates generally to a visual tactical pet locating system and method and, more specifically, relates to a system and method of tracking and monitoring a location of a pet.

### BRIEF DESCRIPTION OF THE DRAWINGS

FIGS. 1a, 1b are schematic illustrations of an example of a pet locating system in accordance with the present disclosure.

FIG. 2 is a schematic illustration of an example of a wearable device of a pet locating system in accordance with the present disclosure.

FIG. 3 is a schematic illustration of an example of a pet locating system in accordance with the present disclosure.

FIG. 4 is a flow chart of an example of a pet locating method in accordance with the present disclosure.

FIG. 5 is a flow chart of an example of a pet locating method in accordance with the present disclosure.

FIG. 6 is a flow chart of an example of a pet locating method in accordance with the present disclosure.

FIG. 7 is a flow chart of an example of a pet locating method in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

The present disclosure pertains to the field of pet care and tracking technology, addressing the desire for reliable pet tracking and monitoring systems. Pet owners often face the challenge of ensuring the safety and well-being of their beloved pets, especially when pets are free to roam or in unfamiliar environments. Existing solutions for pet tracking and monitoring have limitations that can compromise the pet owner's peace of mind.

Traditional pet tracking methods, such as ID tags or microchips, provide only static information and don't offer real-time location updates. Although Global Positioning System (GPS) tracking devices for pets are available, many don't integrate seamlessly with more cost-effective technologies like Bluetooth, which can be employed to create a virtual geo-fence for the pet.

Moreover, the sense of security and peace of mind for pet owners is often diminished by the costs associated with many current pet tracking technologies. These systems typically rely on continuous Wi-Fi connections and utilize packet polling to detect when pets leave designated premises. When pets venture outside the confines of their home, the financial burden and the constant need for connectivity highlight the shortcomings of such devices, especially in scenarios where pets may get lost or need prompt retrieval.

To address these challenges and provide a comprehensive solution for pet owners, the system and method of the present disclosure combines Bluetooth technology, Wi-Fi connectivity, cloud services, cellular communication, and GPS tracking into a single, integrated device. By doing so, the system and method of the present disclosure seeks to offer pet owners an advanced tool to monitor and locate their pets in real time, as well as provide safety for the pet by providing a lighting visual so that the pet can be seen by others.

The device of the present disclosure encompasses both manual and preset settings for an included illumination feature, designed to visually distinguish the pet. By activating this illumination, it signals to the general public that the animal may be in distress, for example, lost or away from home.

The combination of Bluetooth beacons within the home, a cloud-based server, and a wearable device attached to (or consisting of) the pet's collar allows for continuous tracking and monitoring, thereby enhancing pet safety and reducing the risk of pets becoming lost or inaccessible.

The system and method of the present disclosure aims to provide pet owners with a holistic solution that encompasses both proximity monitoring within the home and location tracking when the pet is beyond a distance threshold, such as, for example, the home's immediate vicinity. Furthermore, the device of the present disclosure offers user-friendly features, such as LED indicators and a power switch, to make the device convenient and adaptable to various scenarios, including visits to parks or veterinary clinics.

In summary, the system and method of the present disclosure is designed to address the shortcomings of existing pet tracking solutions by leveraging a combination of technologies, connectivity options, and user-friendly features, ultimately ensuring the safety, security, and peace of mind of pet owners.

The following detailed description outlines components and functionalities of the device, emphasizing the ability to track the pet's location, monitor proximity to home beacons, and communicate effectively with the pet owner through both Wi-Fi and cellular networks. It also highlights the convenience features, such as LED indicators and a power switch, that enhance the device's usability.

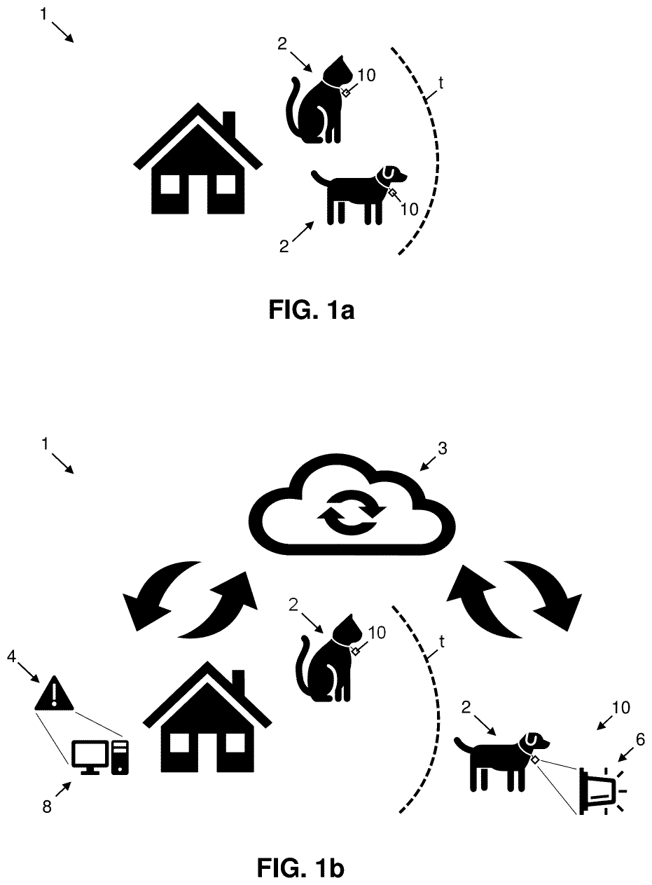

FIGS. 1a, 1b are schematic illustrations of an example of a pet locating system in accordance with the present disclosure. In examples, pet locating system 1 includes a device 10 designed to be attached to (or consisting of) a collar for a pet 2 for the purpose of tracking the pet's location and initiating an alert 4 to the pet owner if the pet 2 is beyond a threshold distance (t), for example, out of Bluetooth range from designated beacons within the pet owner's home. In examples, the system 1 also illuminates a light 6 (or lights) of the device 10 if the pet is beyond the threshold distance (t).

In examples, a communication system 3 facilitates the exchange and/or transmission of information and/or data between the device 10 and another device or system, including an external device 8 such as, for example, a computing device or other electronic device. Such information and/or data may include, for example, control and/or logic instructions or commands, condition or state information, as well as other information and/or data to be exchanged with and/or transmitted to and/or from the device 10. In examples, the communication system 3 transmits location information and/or alerts 4 of the device 10 to the external device 8 such as, for example, a computing device or other electronic device (for example, a mobile phone) of the pet owner.

In examples, as further described herein, the device 10 utilizes a combination of Bluetooth technology, Wi-Fi, cloud services, and a cellular modem to provide the following features:

Bluetooth Connectivity: In examples, the device 10 includes a Bluetooth scanner to detect designated Bluetooth beacons, for example, inside the pet owner's home or within a predefined area.

Wi-Fi and Cloud Connectivity: In examples, the device 10 connects to the home's Wi-Fi network and sends status updates to the cloud server when the pet is within Bluetooth range or when the pet's beacon is no longer detected.

Text Message Alerts: In examples, upon detecting that the pet is out of Bluetooth range from the Bluetooth beacons, the device 10 triggers an alert 4, such as a text message alert, to a predefined recipient, such as the pet owner. In examples, the alert 4 includes a link to access the pet's GPS location, namely, the GPS location of the pet wearing the device 10.

Illumination: In examples, upon detecting that the pet is out of Bluetooth range from the Bluetooth beacons, the device 10 illuminates a light 6 (or lights) to provide a visual to signal to others that the animal may be in distress, for example, lost or away from home.

GPS Tracking: In examples, the device 10 includes GPS functionality, allowing the pet owner to request the pet's real-time GPS location through the cloud server.

Battery and Power Management: In examples, the device 10 is equipped with a battery, such as, for example, a rechargeable LiPo battery, and includes a power switch to allow the pet owner to turn the device 10 off when necessary.

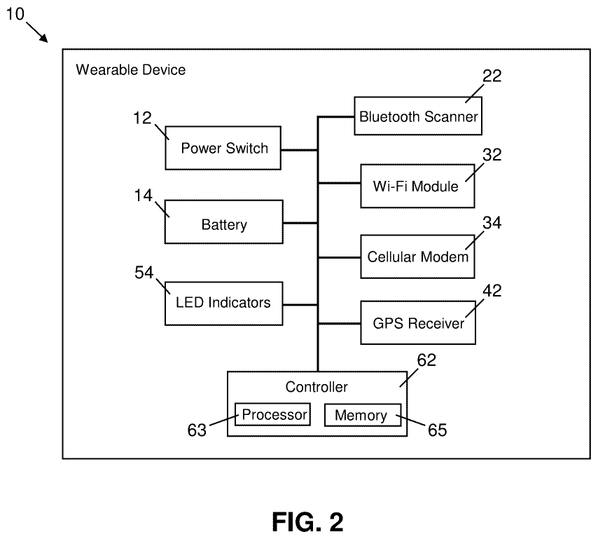

FIG. 2 is a schematic illustration of an example of a wearable device of a pet locating system in accordance with the present disclosure. In examples, the device 10 is designed to attach securely to a pet's collar. In other examples, the device 10 is a pet's collar itself. In examples, the device 10 incorporates technology to provide comprehensive tracking and communication capabilities.

In examples, the device 10 includes the following components:

Bluetooth Scanner: In examples, the device 10 is equipped with a Bluetooth scanner 22 that continually scans for and detects designated Bluetooth beacons, for example, within the pet owner's home or within a predefined area. In examples, the Bluetooth beacons serve as reference points for proximity monitoring.

Wi-Fi Module: In examples, the device 10 includes a Wi-Fi module 32 that allows the device 10 to connect to the Wi-Fi network, for example, the pet owner's home Wi-Fi network. In examples, the Wi-Fi Module 32 facilitates communication with a cloud-based server and enables real-time data transmission.

Cloud Services: In examples, a cloud server is utilized to store and manage data related to the pet's location and status. In examples, the device 10 communicates with the server to send updates and receive commands from the pet's owner.

Cellular Modem: In examples, the device 10 includes a cellular modem 34 that enables communication with the cloud server even when the pet is outside the Wi-Fi range of the Wi-Fi network or the device 10 is disconnected from the Wi-Fi network. Thus, in examples, the cellular connectivity ensures uninterrupted tracking capabilities.

GPS Receiver: In examples, to provide accurate location data, the device 10 is equipped with a GPS receiver 42. The GPS functionality allows the pet owner to request and receive the real-time location of the pet when desired.

LED Indicators: In examples, the device 10 includes LED indicators 54, which are designed to light up in specific patterns or colors to signal different states or events. In examples, when the pet is out of Bluetooth range or the Bluetooth beacons are no longer detected, the LEDs 54 are activated to help locate the pet and to alert others that the pet may be under distress, for example, lost or away from home. The LEDs 54 also provide a way for passing motorists to visibly see the pet in case the pet wanders into danger.

Battery: In examples, power for the device 10 is supplied by a battery 14, such as, for example, a rechargeable lithium-polymer (LiPo) battery. In examples, the battery 14 offers sufficient capacity to ensure continuous operation and can be recharged as needed.

Power Switch: In examples, for user convenience, the device 10 includes a power switch 12 that allows the pet owner to deactivate the device 10 temporarily. This feature is useful, for instance, when the pet is in a controlled environment where tracking is unnecessary.

Controller: In examples, the device 10 includes a controller 62, with a processor 63 and memory 65. The processor 63 transfers, communicates, and/or processes signals, commands, conditions, states, and/or parameters for and/or between components of the device 10, and may include analog and/or digital elements and/or circuits. In examples, the processor 63 implements and/or executes computer-readable, computer-executable instructions for data processing functions and/or functionality of the device 10, as well as the system and method. In examples, such instructions are stored in memory, such as memory 65. Memory 65 may include volatile and non-volatile memory, and includes a non-transitory computer-readable storage medium suitable for tangibly embodying program instructions and data.

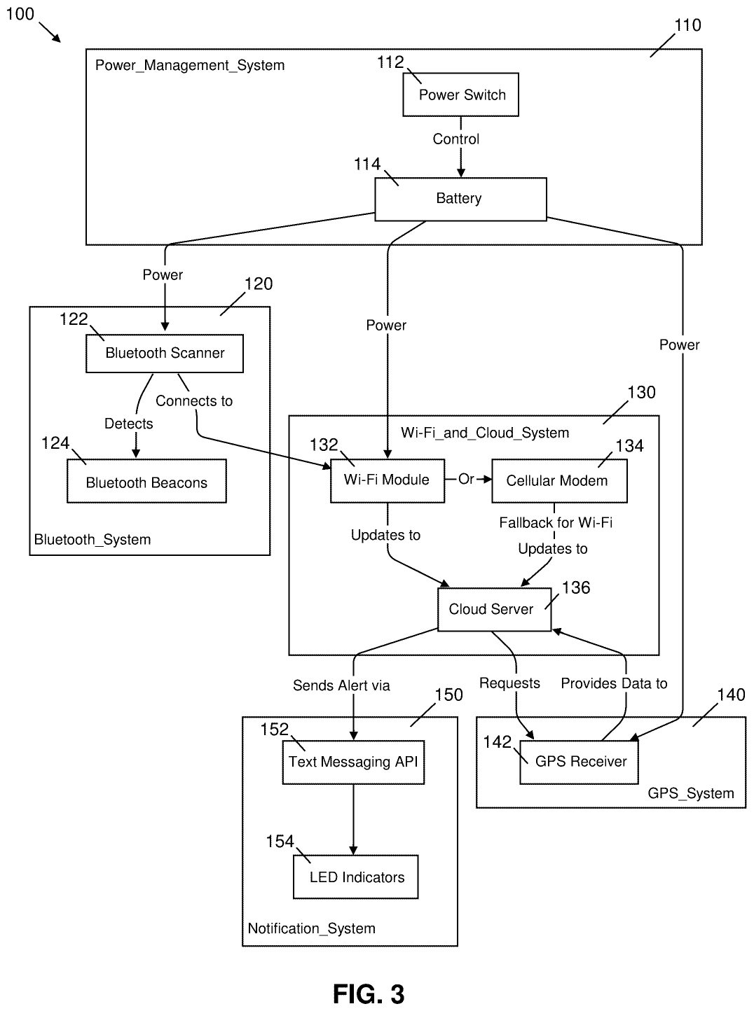

FIG. 3 is a schematic illustration of an example of a pet locating system in accordance with the present disclosure. In examples, the pet locating system 100 includes a Power Management System 110, a Bluetooth System 120, a Wi-Fi and Cloud System 130, a GPS System 140, and a Notification System 150. In examples, components and/or functionalities of these systems are distributed and/or implemented in the device 10.

In examples, operation of the device 10 and implementation of the systems (namely, the Power Management System 110, the Bluetooth System 120, the Wi-Fi and Cloud System 130, the GPS System 140, and the Notification System 150) can be summarized as follows:

Power: In examples, power is supplied by a battery 114 (see, for example, the battery 14 of FIG. 2), and a power switch 112 (see, for example, the power switch 12 of FIG. 2) allows the pet owner to turn the device 10 on and off as desired.

Proximity Monitoring: In examples, the Bluetooth scanner 122 (see, for example, the Bluetooth scanner 22 of FIG. 2) continuously monitors the presence of designated Bluetooth beacons 124, for example, inside the pet owner's home or within a predefined area. If the device 10 no longer detects the Bluetooth beacons or if the pet moves out of their range (based on Received Signal Strength Indicator, RSSI), an alert is triggered.

Wi-Fi and Cloud Communication: In examples, the device 10 connects to the home's Wi-Fi network via the Wi-Fi module 132 (see, for example, the Wi-Fi module 32 of FIG. 2) and regularly sends status updates to the cloud server 136. These updates include the current status of Bluetooth beacon detection and GPS coordinates as provided by the GPS receiver 142 (see, for example, the GPS receiver 42 of FIG. 2) if requested by the pet owner. In examples, if the pet moves out of the home's Wi-Fi range, the cellular modem 134 (see, for example, the cellular modem 34 of FIG. 2) takes over and provides a fallback for sending status updates to the cloud server 136 in the absence of a Wi-Fi signal, ensuring uninterrupted communication with the cloud server 136 and enabling real-time tracking.

Alert Notifications: In examples, when the device 10 determines that the pet is out of Bluetooth range or away from the home, an alert notification is sent to a predefined recipient, such as the pet owner, via text message by the text messaging API 152. In examples, the message contains a link to access the pet's real-time GPS location, namely, the GPS location of the pet wearing the device 10. In examples, when the pet is out of Bluetooth range or the Bluetooth beacons are no longer detected, the LED indicators 154 (see, for example, the LED indicators 54 of FIG. 2) are activated.

GPS Tracking on Demand: In examples, the pet owner has the ability to request the pet's GPS location by sending a command to the device 10 through the cloud server 136. In examples, the GPS receiver 142 (see, for example, the GPS receiver 42 of FIG. 2) responds by providing the GPS coordinates of the pet wearing the device 10.

The following is an overview of a process of operation of the device 10:

Initialization: In examples, upon activating the device 10 via the power switch 12, 112, the device 10 begins initializing the systems (for example, the Power Management System 110, the Bluetooth System 120, the Wi-Fi and Cloud System 130, the GPS System 140, and the Notification System 150). In examples, the LED indicators 54, 154 flash a specific color or pattern, indicating the device 10 is starting up.

Connectivity Establishment: In examples, the device 10 connects to the Wi-Fi network (via the Wi-Fi module 32, 132). In examples, the device 10 also establishes communication with the cloud server 136 to synchronize the current status of the device 10 and any pending commands from the pet owner.

Proximity Monitoring via Bluetooth: In examples, the Bluetooth scanner 122, 22 starts monitoring for designated Bluetooth beacons 124, for example, inside the pet owner's home or within a predefined area. In examples, the device 10 continuously assesses the strength of signals from the Bluetooth beacons 124 using RSSI values.

Status Update: In examples, the device 10 regularly sends status updates to the cloud server 136 regarding the pet's proximity to the Bluetooth beacons 124. This ensures real-time data availability.

Pet Leaves Bluetooth Range: In examples, if the device 10 no longer detects the Bluetooth beacons 124 or the signal strength drops below a certain threshold, indicating the pet has moved out of range, the device 10 transitions to an alert mode.

Alert Mode Activation: In examples, the LED indicators 154, 54 light up, indicating the pet is potentially lost or in distress. In examples, the LED indicators 154, 54 light up in a distinctive pattern or color(s). In examples, the distinctive pattern includes a word or message. In examples, the device 10 sends a text message alert (via the text messaging API 152) to a predefined recipient, such as the pet owner. In examples, the alert contains a link that provides real-time GPS location of the pet wearing the device 10.

GPS Tracking: In examples, the device 10 activates the GPS receiver 142, 42 to obtain the pet's real-time location. In examples, if the pet remains out of Bluetooth range for an extended period or the pet owner manually requests the location, the device 10 sends the GPS coordinates to the cloud server 136, which then relays this information to the pet owner (via the Notification System 150).

Cellular Backup: In examples, if the pet moves out of the home's Wi-Fi range or the device 10 is disconnected from the Wi-Fi network, the cellular modem 134, 34 takes over, ensuring uninterrupted communication with the cloud server 136 and enabling real-time tracking.

Battery Management: In examples, the device 10 continuously monitors its battery levels. In examples, if the battery reaches a critically low charge level, the device 10 sends a notification to the pet owner advising them to recharge the device 10.

Manual Deactivation: In examples, if desired, the pet owner can use the power switch to turn off the device 10, such as during times when tracking is unnecessary.

This process flow offers a simplified understanding of how the device 10 functions and operates, for example, from initialization to providing location updates to the pet owner. Notably, while this process flow simplifies the operation for understanding purposes, the device's actual working involves hardware and/or software operations, with the associated hardware and/or software operations including machine readable instructions (including firmware and/or software) embodied on a computer readable medium, for implementing and/or executing computer-readable, computer-executable instructions for data processing functions and/or functionality of the system and method.

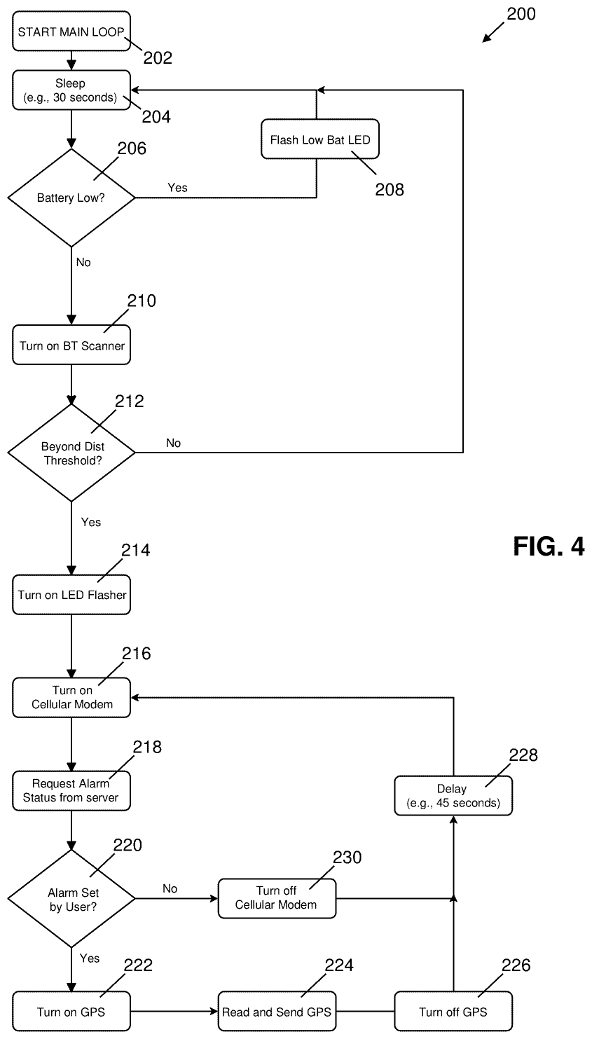

FIG. 4 is a flow chart of an example of a pet locating method in accordance with the present disclosure. More specifically, FIG. 4 is a flow chart of an example of operations of a pet locating method 200. In examples, and as further outlined and described herein, the pet locating method 200 includes, at 202, starting a main loop initialization. At 204, the method 200 includes entering a sleep mode (for example, 30 seconds). At 206, the method 200 includes assessing whether the battery (for example, the battery 14, 114) is low (for example, less than 5 percent). If, at 206, the battery is low, at 208, the method 200 includes flashing a low battery LED. If, at 206, the battery is not low, at 210, the method 200 includes turning on the Bluetooth scanner (for example, the Bluetooth scanner 22, 122). At 212, the method 200 includes assessing whether the device 10 is beyond a distance threshold (for example, the distance threshold t). If, at 212, the device 10 is not beyond the distance threshold, the method 200 returns to the sleep mode at 204. If, at 212, the device 10 is beyond the distance threshold, at 214, the method 200 includes turning on the LED flasher or LED indicators (for example, the LED indicators 54, 154). At 216, the method 200 includes turning on the cellular modem (for example, the cellular modem 34, 134). At 218, the method 200 includes requesting an alarm status from the server (for example, the cloud server 136). At 220, the method 200 includes determining whether an alarm has been set by the user (i.e., the pet owner). If, at 220, an alarm has not been set by the user, at 230, the method 200 includes turning off the cellular modem. If, at 220, an alarm has been set by the user, at 222, the method 200 includes turning on the GPS (for example, the GPS receiver 42, 142). At 224, the method 200 includes reading and sending the GPS location of the device 10, namely, the GPS location of the pet wearing the device 10. At 226, the method 200 includes turning off the GPS. At 228, the method 200 includes a delay (for example, 45 seconds). After the delay at 228, the method 200 includes, at 216, turning on the cellular modem.

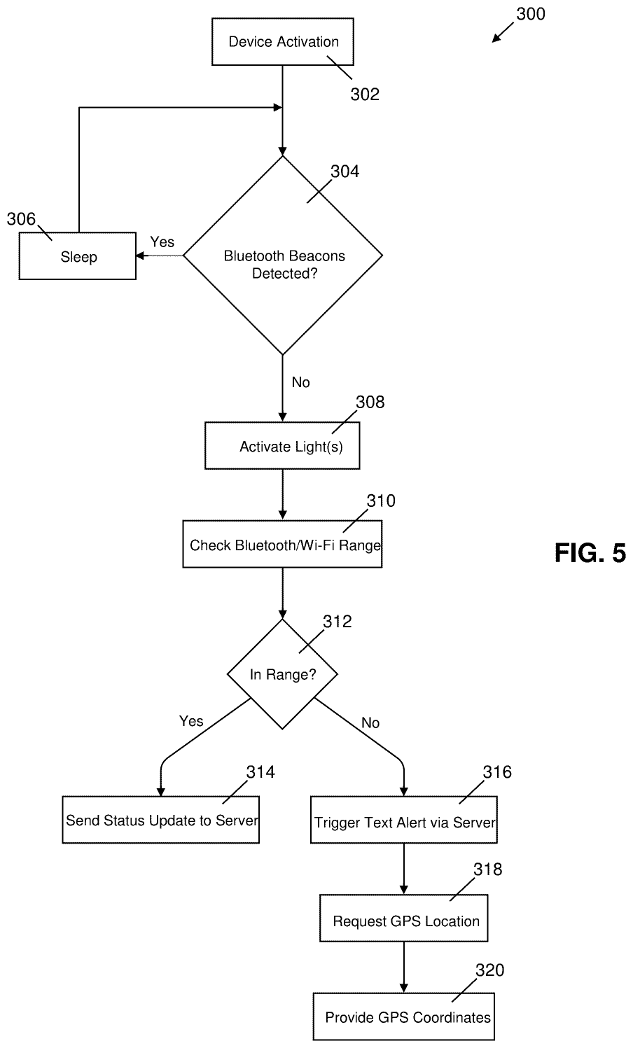

FIG. 5 is a flow chart of an example of a pet locating method in accordance with the present disclosure. More specifically, FIG. 5 is a flow chart of an example of operations of a pet locating method 300. In examples, and as further outlined and described herein, the pet locating method 300 includes, at 302, activating the device 10. At 304, the method 300 includes assessing whether the Bluetooth beacons (for example, the Bluetooth beacons 124) are detected. If, at 304, the Bluetooth beacons are detected, at 306, the method 300 includes entering a sleep mode. If, at 304, the Bluetooth beacons are not detected, at 308, the method 300 includes activating the light(s) (for example, the LED indicators 54, 154). At 310, the method 300 includes checking the Bluetooth/Wi-Fi range. At 312, the method 300 includes assessing whether the device 10 is in the range. If, at 312, the device 10 is in the range, at 314, the method 300 includes sending a status update to the server (for example, the cloud server 136). If, at 312, the device 10 is not in the range, at 316, the method 300 includes triggering a text alert via the server. At 318, the method 300 includes requesting the GPS location of the device 10, namely, the GPS location of the pet wearing the device 10. At 320, the method 300 includes providing the GPS coordinates of the device 10 to the pet owner.

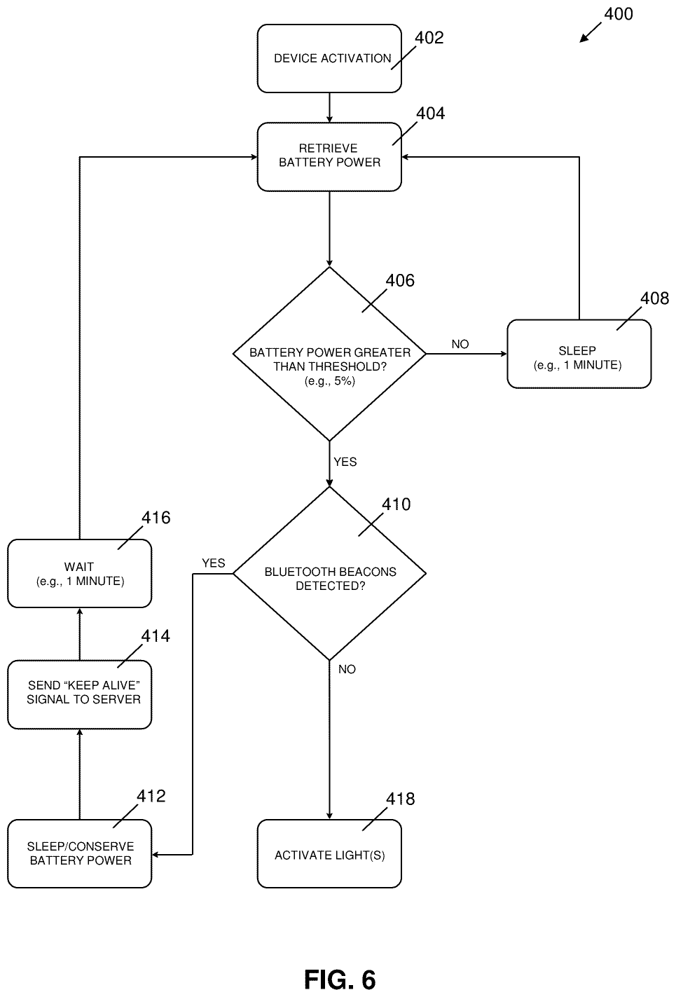

FIG. 6 is a flow chart of an example of a pet locating method in accordance with the present disclosure. More specifically, FIG. 6 is a flow chart of an example of operations of a pet locating method 400 implemented at the device 10. In examples, and as further outlined and described herein, the pet locating method 400 includes, at 402, activating the device 10. At 404, the method 400 includes retrieving the battery power. At 406, the method 400 includes assessing whether the battery power is greater than a threshold (for example, 5 percent). If, at 406, the battery power is not greater than the threshold, at 408, the method 400 includes entering a sleep mode (for example, 1 minute). If, at 406, the battery power is greater than the threshold, at 410, the method 400 includes assessing whether the Bluetooth beacons (for example, the Bluetooth beacons 124) are detected. If, at 410, the Bluetooth beacons are detected, at 412, the method 400 includes entering a sleep/conserve battery power mode. At 414, the method 400 includes sending a “keep alive” signal to the server (for example, the cloud server 136). At 416, the method 400 includes waiting a predetermined time (for example, 1 minute). If, at 410, the Bluetooth beacons are not detected, at 418, the method 400 includes activating the light(s) (for example, the LED indicators 54, 154).

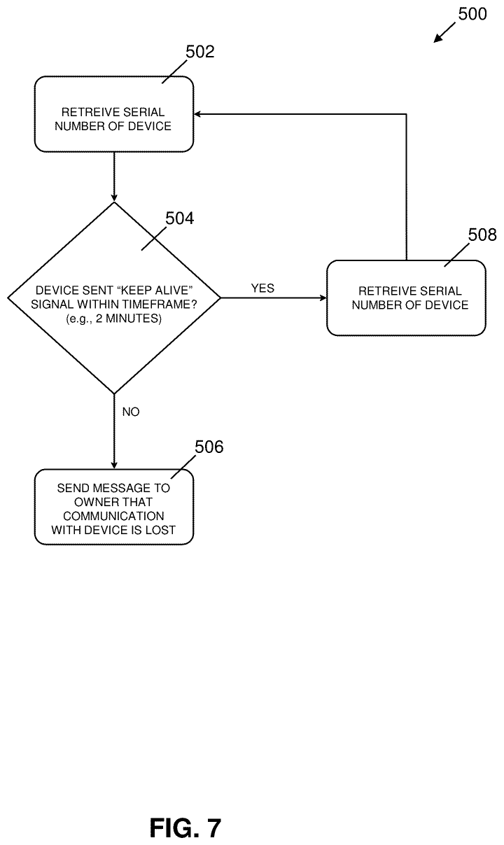

FIG. 7 is a flow chart of an example of a pet locating method in accordance with the present disclosure. More specifically, FIG. 7 is a flow chart of an example of operations of a pet locating method 500 implemented at the server (for example, the cloud server 136). In examples, and as further outlined and described herein, the pet locating method 500 includes, at 502, retrieving the serial number of the device 10. At 504, the method 500 includes assessing whether the device 10 has sent a “keep alive” signal within a predetermined timeframe (for example, 2 minutes). If, at 504, the device 10 has sent a “keep alive” signal within the timeframe, at 508, the method 500 includes retrieving the serial number of the device 10. If, at 504, the device 10 has not sent a “keep alive” signal within the predetermined timeframe, at 506, the method 500 includes sending a message to a predefined recipient, such as the pet owner, that communication with the device 10 has been lost.

In examples, a pet tracking device includes: a Bluetooth scanner designed to monitor and detect designated Bluetooth beacons within a predefined area, a Wi-Fi module enabling connectivity to a wireless network for communication with a cloud-based server, a cellular modem facilitating communication with the cloud-based server when outside the range of the wireless network, and a GPS receiver to obtain real-time location data of a pet wearing the device.

In examples, the pet tracking device further includes LED indicators designed to illuminate in specific patterns or colors to signal different states or events, including when the pet is out of range from the designated Bluetooth beacons.

In examples, upon the device detecting a drop in received signal strength from the Bluetooth beacons below a threshold or no longer detecting the Bluetooth beacons, the pet tracking device automatically activates an alert mode.

In examples, the alert mode triggers activation of the LED indicators.

In examples, the alert mode triggers transmission of a text message alert to a predefined recipient, the message containing a link to access real-time GPS location data of the pet wearing the device.

In examples, the pet tracking device further includes a rechargeable LiPo battery, wherein the device monitors its battery levels and notifies a user when recharging is needed.

In examples, the pet tracking device regularly sends status updates to the cloud-based server about the presence or absence of the Bluetooth beacons.

In examples, the pet tracking device further includes a power switch allowing for manual deactivation of the device.

In examples, a method for tracking a pet using the device includes continuously monitoring the presence of designated Bluetooth beacons inside a predefined area, communicating the status of the monitoring to a cloud server, activating an alert mode when the pet is determined to be out of range of the Bluetooth beacons, and providing real-time GPS location data of the pet upon request.

In examples, the method further includes sending an alert notification to a predefined recipient when the pet is determined to be out of range, the notification containing a link to the real-time GPS location data.

In examples, the cloud server send commands to the device, prompting the device to provide specific data or perform specific actions.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A pet tracking device to be worn by a pet, comprising:
a Bluetooth scanner to monitor a status of a presence or an absence of Bluetooth beacons within a predefined area,
a Wi-Fi module to connect to a wireless network to communicate the status with a cloud-based server,
a cellular modem to communicate the status with the cloud-based server when the device is outside a range of the wireless network, and
a GPS receiver to obtain location data of a pet wearing the device and communicate the location data with the cloud-based server.

2. The pet tracking device of claim 1, further comprising:
LED indicators to illuminate to signal a state or event.

3. The pet tracking device of claim 2, wherein:
the LED indicators to illuminate when the pet wearing the device is out of range of the Bluetooth beacons.

4. The pet tracking device of claim 2, wherein:
the LED indicators to illuminate in specific patterns or colors to signal different states or events.

5. The pet tracking device of claim 1, wherein:
when the device detects a drop in received signal strength from the Bluetooth beacons below a threshold or the device no longer detects the Bluetooth beacons, the device to activate an alert mode.

6. The pet tracking device of claim 5, wherein:
the alert mode to trigger activation of an LED indicator of the device.

7. The pet tracking device of claim 5, wherein:
the alert mode to trigger transmission of a text message alert to a predefined recipient, the message to provide the location data of the pet wearing the device.

8. The pet tracking device of claim 1, further comprising:
a rechargeable battery, the device to monitor a charge level of the battery and provide notification when recharging is needed.

9. The pet tracking device of claim 1, wherein:
the device to regularly send a status update to the cloud-based server about the presence or the absence of the Bluetooth beacons.

10. The pet tracking device of claim 1, further comprising:
a power switch to enable manual activation and deactivation of the device.

11. A pet locating system, comprising:
a plurality of Bluetooth beacons within a predefined area; and
a pet tracking device to be worn by a pet, the device including:
a Bluetooth scanner to detect the Bluetooth beacons,
a Wi-Fi module to connect to a wireless network to communicate a status of detection of the Bluetooth beacons with a cloud-based server,
a cellular modem to communicate the status of detection of the Bluetooth beacons with the cloud-based server when the device is outside a range of the wireless network, and
a GPS receiver to obtain location data of a pet wearing the device and communicate the location data with the cloud-based server.

12. The pet locating system of claim 11, wherein:
when the device detects a drop in received signal strength from the Bluetooth beacons below a threshold or the device no longer detects the Bluetooth beacons, the device to activate an alert mode.

13. The pet locating system of claim 12, wherein:
the alert mode to trigger activation of an LED indicator of the device.

14. The pet locating system of claim 12, wherein:
the alert mode to trigger transmission of a text message alert to a predefined recipient, the message to provide the location data of the pet wearing the device.

15. A method of tracking a pet with a wearable device, comprising:
monitoring, with the device, the presence of Bluetooth beacons within a predefined area;
communicating, from the device, a status of the monitoring to a cloud server;
activating, with the cloud server based on the status of the monitoring, an alert mode when a pet wearing the device is out of range of the Bluetooth beacons; and
providing, from the device via the cloud server, GPS location data of the pet wearing the device to a predefined recipient.

16. The method of claim 15, wherein monitoring the presence of the Bluetooth beacons comprises:
monitoring the presence of the Bluetooth beacons with a Bluetooth scanner of the device.

17. The method of claim 15, wherein communicating the status of the monitoring to the cloud server comprises:
communicating the status of the monitoring to the cloud server via a Wi-Fi module of the device, the Wi-Fi module to connect to a wireless network.

18. The method of claim 17, wherein communicating the status of the monitoring to the cloud server comprises:
when the device is outside a range of the wireless network, communicating the status of the monitoring to the cloud server via a cellular modem of the device.

19. The method of claim 15, wherein activating the alert mode comprises:
illuminating an LED indicator of the device when the pet wearing the device is out of range of the Bluetooth beacons.

20. The method of claim 15, wherein activating the alert mode comprises:
sending an alert notification to the predefined recipient when the pet wearing the device is out of range of the Bluetooth beacons, the alert notification including the GPS location data of the pet wearing the device.
